(19) United States
(12) Patent Application Publication
(10) Pub. No.: US 2003/0084403 A1
(43) Pub. Date: May 1, 2003

(54) Method and system for processing of information

(75) Inventor: Michel Gaultier, Vienna (AT)

Correspondence Address: U.S. Philips Corporation, 580 White Plains Road, Tarrytown, NY, 10591, US

(73) Assignee: KONINKLIJKE PHILIPS ELECTRONICS N.V.

(21) Appl. No.: 10/277,586

(22) Filed: Oct. 22, 2002

(30) Foreign Application Priority Data
Oct. 25, 2001 (EP) 01 000 571.8

(51) Int. Cl. G06F 15/00

(52) U.S. Cl. 715/506

(57) ABSTRACT

During processing of information made available in electronic form and provided in electronic form for output after processing, detailed work steps are automatically recorded with respect to their time taken, and efficiency information indicating the efficiency of these detailed work steps is compiled on the basis thereof and provided for output.

The invention relates to a method of processing information which is made available in electronic form and is provided after processing in electronic form for output.

The invention further relates to a system for processing of information with means for performing individual steps during processing of the information and with means for output of the processed information.

A typical field in which such processing of information is performed is the transcription of dictations, in which case speech recognition means are often used for automatic compilation of text files, the output files of which are subsequently checked, and optionally corrected, by an individual while listening to at least part of the dictation. Further to word-processing steps that are conventional per se, for example deleting of symbols, overwriting of symbols, and insertion of symbols, this activity hence also comprises hearing the dictation, which entails fast and slow listening or controlling of particular dictation sections, fast skipping of dictation sections, text formatting, administrative activities, such as archiving, communication etc., and further operational activities as constituent steps. It should also be mentioned here that, in the case of those digital dictation playback units which are customary at present, the pitch of the dictator's speech remains the same during faster or slower listening to the dictated text.

A comparable situation exists in the processing of image information, for example in the area of advertising graphics or architecture. Here, for example, combinations of stored pixels are revised with respect to size and arrangement of these pixels, coloration, etc., and as in the case of processing of text information, this involves typical individual constituent steps such as enlarging, reducing, shifting of pixels, superimposing with other colors, etc.

A further field of application is the processing of translation texts compiled automatically with the aid of a translation program, in which case individual work steps are to be performed in the field of word-processing when revising the translated text information, as in the case of dictation transcriptions, here with reference to a specific text in the source language.

The individuals who perform such information processing often work with their own billing, a bill being based on lines of text finally delivered, for example, in the case of transcription. It would be very beneficial for these individuals if they had constant information available about the efficiency of their activity when processing the information, for example in order to improve the efficiency of specific work activities, for example listening to dictations. Another conceivable form of improvement involves, for example, a more expedient selection of information to be processed when it is found that particular texts, for example legal texts, are being processed better than other texts, for example medical texts, by the processing individual.

U.S. Pat. No. 4,301,525 A discloses a system for monitoring transcription activities; this, however, involves a central monitoring of a plurality of dictation and transcription stations, an independent monitoring individual, a so-called supervisor, being provided primarily with information such as throughput times, i.e. how much time elapses, for example, from the instant when a dictation is ready until the instant when this dictation has been allocated to an individual for the purpose of processing, or the duration from the instant of allocating a dictation to a processing individual until the instant of completion of the processing of the text etc. The information obtained in this way can be generally used for organization of a transcription office, although it is not suitable for directly giving the individuals performing the processing, for example transcriptionists or correctors, information regarding the efficiency of their individual activities.

It is therefore an object of the invention to offer assistance here, and to make available a system as indicated in the introduction, in order for individuals who process information to have access to more detailed efficiency information, preferably in real time, so that these individuals can thereupon optimize their work practice.

According to a first aspect, in order to achieve this object, the invention therefore provides a method of processing information, which information is made available in electronic form and is provided after processing in electronic form for output, wherein detailed work steps in the processing of the information are automatically recorded with respect to their time taken, and efficiency information is compiled on the basis thereof and provided for immediate output, which efficiency information indicates the efficiency of said detailed work steps

According to a second aspect, in order to achieve this object, the invention provides a system for processing information with means for performing individual work steps in the processing of the information and with means for providing the processed information, wherein the means for performing the individual work steps are assigned further means for recording the time taken by individual detailed work steps and for compiling efficiency information which indicates the efficiency of these detailed work steps, which further means are connected to means for making this efficiency information available for output.

With the aid of the measures according to the invention, it is immediately possible in the processing of information, for example in the scope of transcribing dictations, to selectively check the efficiency of individual processing operations or activities and thereupon expediently train such processing operations, during which processing operations much time is lost in relation to the overall processing, for example in the event of prolonged slow hearing of dictations in parallel with reading a text compiled automatically with the aid of speech recognition software, while the text passages are obviously faultless. The efficiency information may in this case be displayed on demand, although it is also conceivable to display it constantly, for example in a window, on a screen being used for processing of the information, so as to immediately provide “feedback” to the person responsible for processing the information. Expediently, the information that indicates the efficiency of equivalent detailed work steps, for instance slow listening to a dictation, repositioning of the cursor in the text, deletion of symbols, etc., is summed so that an efficiency report about the entire information processing performed so far can be given in detail in terms of these different types of detailed work steps. In this case, furthermore, it is useful not only to sum this efficiency information, but also to express it in terms of specific work units, for example time units or alternatively text units, for instance so as to obtain reports that 20% of a time unit has been spent on one particular processing activity, and 10% on another activity, etc. In the case of transcription of texts, it is expedient to express the summed efficiency information, that is to say to “normalize” it, in terms of lines of text since, in the case of transcription, the billing amounts are usually determined on the basis of the lines of text contained in the text (apart from other criteria, such as complexity of the text, urgency of the processing, etc.) so that an efficiency report immediately related to the work result to be billed is obtained for the different activities.

In the present efficiency monitoring, it is also possible to automatically detect those time periods in which no processing operations are actually carried out in the scope of processing of information, so that the proportion of the pause times during the information processing can be found and reported, for example normalized to a time unit, or alternatively to a text unit in the case of processing a text. In this case, of course, only genuine pause times should be recorded, that is to say the short pause times when changing from one work step to another work step, such as moving a cursor when processing a text, on the one hand, and subsequently deleting or overwriting individual symbols, on the other hand, are not recorded as pause times. Minimum time durations, for instance 10 s or 20 s, are therefore expediently specified, so as to record pauses with a time duration which is longer than this minimum time duration, but not to record shorter interruptions.

In order to make good or poor efficiency during processing of information readily apparent to the individual performing the processing, efficiency information for individual processing activities may, be converted into fictitious cash or pay information, or billing information in general, especially after summation, and may be displayed, and this billing information for individual working operations may also be output as fractions of total pay per work unit, for example the charging rate per line. Conversion, that is to say normalization, based on an hourly pay, however, is also conceivable.

The efficiency information obtained may also be stored so as to be available for subsequent comparisons. In this case, the individuals performing the processing are able to check whether or not, when considered over an extended time period, an improvement has been achieved concerning the specific efficiency for particular work steps. Similarly, it is also possible to check whether an improvement in efficiency has been achieved with respect to particular information, for example during processing of particular types of text in the case of transcription activities. The same also applies, of course, to other information processing, for example image information processing. On the basis of the comparisons thus made, conclusions may also be drawn about the software being used, for example the speech recognition software for the transcription of dictations, or alternatively the software for automatic compilation of translations, or the software for image processing, i.e. it is possible to find whether some software being used is better for particular tasks, but is less suitable for other tasks.

These and other aspects of the invention will be elucidated with reference to a preferred embodiment, which is not intended to imply any limitation, and the Figures contained in the appended drawings.

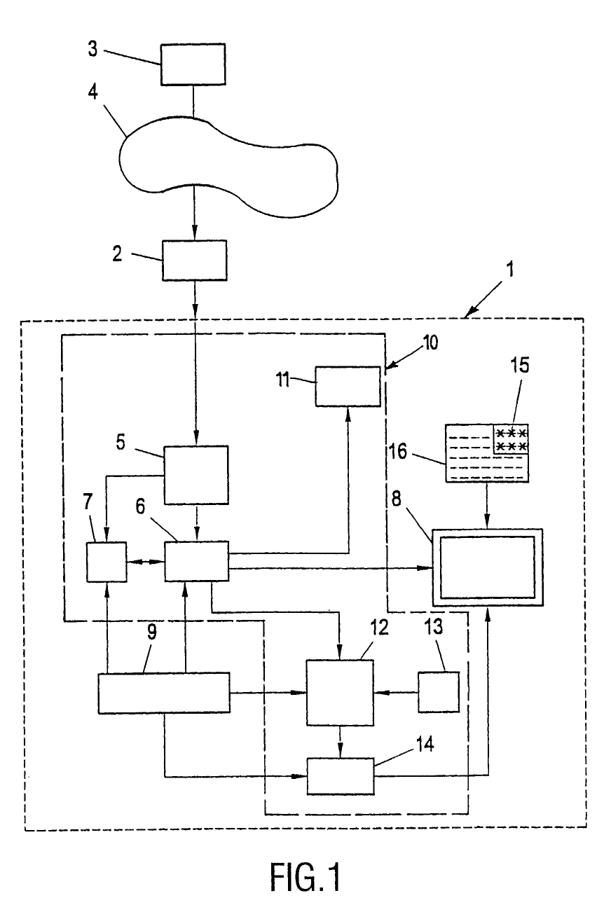

FIG. 1 shows schematically, in the form of a block diagram, a system for processing information, namely for transcription of dictations, with individual efficiency recording.

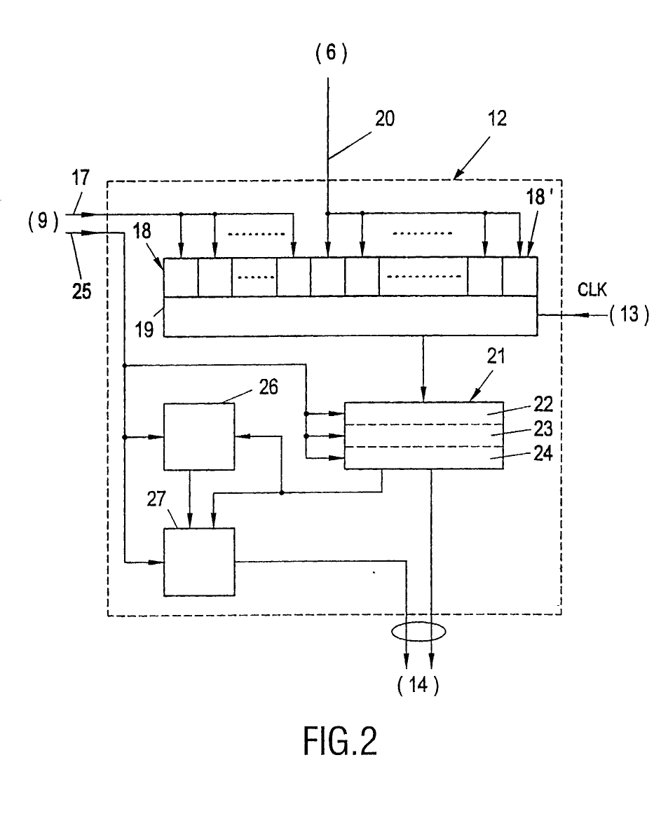

FIG. 2 shows, in the form of a block diagram, means for recording individual detailed work steps in relation to time taken and efficiency.

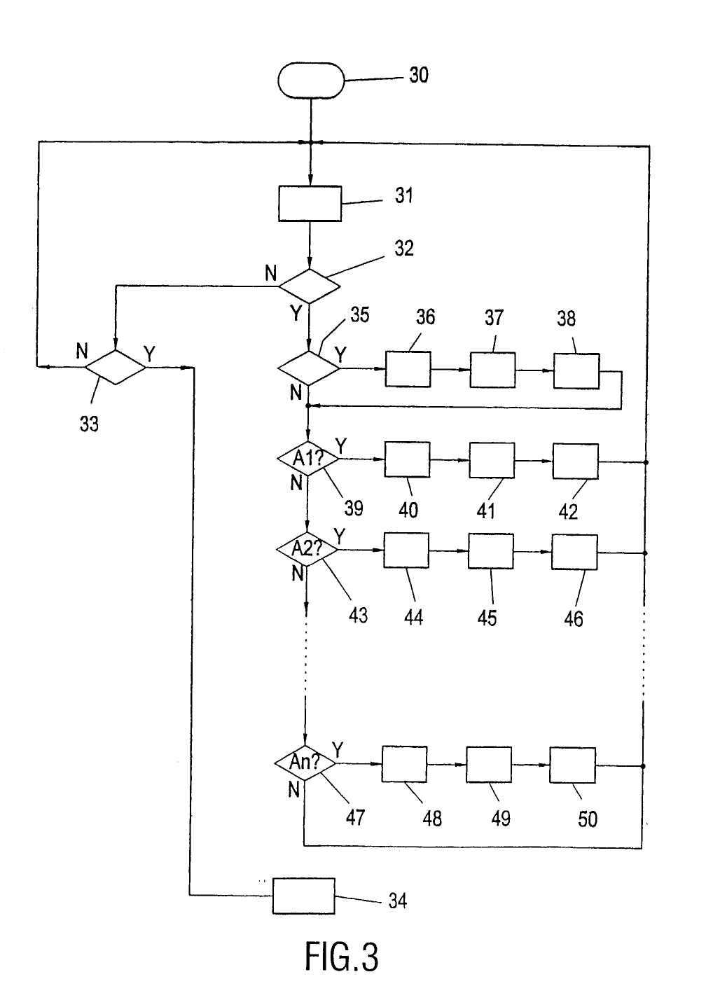

FIG. 3 illustrates, in the form of a flowchart, the operating procedure of the system of FIG. 1.

As an example of processing of information while simultaneously obtaining efficiency information, FIGS. 1 to 3 illustrate the transcription of a dictation and the revision of a text that is automatically compiled in this case with the aid of speech recognition software, using a transcription system. Of course, the invention is not restricted to such a system, but may also be applied to other systems for processing of information, for example to systems for compiling translations with the aid of translation software and for processing of the automatically compiled translated text, or alternatively to a system for processing images for advertising or architecture offices.

In detail, FIG. 1 represents, framed by a dashed line, a transcription workstation 1 forming the system for processing information. This transcription workstation 1 is assigned a transmission/reception unit 2 which is designed to transmit and to receive in order to receive transcription jobs from a client 3 via a communication link 4, for example the Internet, a LAN, or a WAN. The transmission/reception unit 2 is formed by a modem, in order to permit communication—that is to say transmission and reception—via the Internet, although other communication means may be employed in the case of a LAN or a WAN. The transcription jobs involve dictation files existing in electronic form, which are each intended to be converted into a text file, and which are to that end delivered to automatic speech recognition means 5. With the aid of these automatic speech recognition means 5, a text file is compiled in a manner which is known per se, and which need not therefore be described in detail here, and this file is sent to means for performing individual work steps during processing of the information contained in the text file, i.e. to word-processing means 6. At the same time, the dictation file associated with the text file is delivered to playback means 7 connected to the word-processing means 6, in order to permit dictation playback coordinated with the display of lines of text contained in the text file on a screen 8. The word-processing means 6 and the playback means 7 are associated with input means 9 which, in particular, may here be a keyboard, preferably in conjunction with a mouse.

The means 5, 6, 7, and 9 described so far are formed by a computer, in particular a PC, as indicated by dashed lines 10 in FIG. 1. This PC then also has a screen 8. The means for providing the processed information contained in the text file are formed in the present case by storage means 11. The storage means 11 are intended for storing the processed information and for making them available. The means for providing the processed information furthermore comprise the screen 8. It may be mentioned that a text output unit (not represented in FIG. 1) may be provided, which may be connected to the word-processing means 6, and the text output unit may be formed by a printer. It is, however, also possible to provide the transmission/reception unit 2 as a text output unit in order to send the compiled text files back to the client 3 via the transmission/reception unit 2 and the communication link 4.

The input means 9 and the word-processing means 6 are furthermore assigned means 12 for recording individual detailed work steps during processing of the text initially compiled automatically by the automatic speech recognition means 5 and for compiling information indicating the efficiency of these detailed work steps. These means, referred to in short hereinafter as efficiency recording means 12, will be further explained below with reference to FIG. 2. These efficiency recording means 12 are intended to measure the time spent on individual activities, i.e. on detailed work steps, during processing of the automatically compiled text in the word-processing means 6, to which end clock pulse generator means 13 are provided for sending a clock signal as a timebase to the efficiency recording means 12. The information indicating the efficiency and derived by the efficiency recording means 12, in short efficiency information, is then sent to means 14 for providing this information for output, in the present case for reproduction on the screen 8, which means 14 are referred to in short hereinafter as provision means 14. In this case, this reproduction may take place selectively in response to delivered control instructions indicated by the input means 9; in the present case, the efficiency information is to be sent constantly by the provision means 14 to the screen 8, and displayed there in a “window” 15, i.e. in a sub-region of the reproduction surface 16 of the screen 8, as is schematically shown by FIG. 1 in association with the screen 8.

Although this is not illustrated in detail in the drawing, the recording of detailed work steps during processing of the text information with respect to their time duration comprises both monitoring of the actuation of the input means 9, for example pressing of particular keys on a keyboard, for instance a cursor key, delete key or insert key, as well as direct monitoring of corresponding control signals in the word-processing means 6 and/or monitoring of menus (not represented in detail in the drawing) on the screen 8 managed via the word-processing means 6. Control instructions for the playback means 7, for instance for fast-forward, rewind, slow play, or fast play of dictations, are recorded here with respect to the type and duration of these actions.

This is illustrated in FIG. 2, in which the structure of the efficiency recording means 12 is shown in more detail. In this case, signal sequences obtained in the event of particular inputs, especially keystrokes, or in the event of particular dictation playback instructions, are sent via a connection 17 to recognition modules 18 inside the efficiency recording means 12, which recognize the individual signal sequences according to their type, for example on the basis of comparison with stored sequences; these signals, or actions, are then measured with respect to their duration, to which end measurement means 19 are provided, to which the clock signal CLK from the clock pulse generator means 13 (see FIG. 1) is also sent. In a comparable way, word-processing signal sequences are sent from the word-processing means 6 to recognition modules 18′ via a connection 20, in order to carry out recording as a function of time in the measurement means 19 after recognition of these word-processing signal sequences.

The information obtained in this way, relating to a duration of detailed work steps just performed, is then sent to processing means 21, in order to sum the durations of equivalent actions, or detailed work steps, in summation means 22, after which the summed information is normalized to specific work units in normalization means 23, for example time units or, preferably in the present case, lines of text; the processing means 21 further comprise conversion means 24 for converting the efficiency information treated in this way, i.e. summed and normalized, into billing or pay information so as to indicate costs for each detailed activity during processing of the information, for example dictation, fast forward, dictation rewind, dictation slow play, text symbol searching, symbol overwriting, symbol deletion, symbol insertion, in each case proportionately, and hence to make meaningful information immediately available regarding activities for which, for example, improvements should in detail be sought. In respect of recording the individual detailed work steps as a function of time in the measurement means 19, it is also readily possible to record pauses between individual work steps with a length longer than a minimum duration (for example 5 or 10 or 20 s) and thereupon to sum them so that overall pause times can also be displayed during processing of a text file.

During summation of the efficiency information in the summation means 22 and normalization in the normalization means 23, provision may also be made to constantly average the efficiency information expressed in terms of a line of text, i.e. after processing of one page of text, the average duration of deletion processes or insertion processes per line of text may—additionally—be displayed. In order to be able to change particular settings specifically on demand, control inputs of the means 22, 23, and 24 are connected via a connection 25 to the input means 9. With the aid of the connection 25, for example, the conversion into billing information may also be turned off, or a conversion into billing information based on different currencies, for example Euros, US dollars, etc., may be turned on.

Provision is furthermore made to store the current efficiency information constantly, and to compare it with earlier stored efficiency information with respect to any changes, especially efficiency improvements; to that end, efficiency storage means 26 and comparator means 27 are connected to the processing means 21. These efficiency storage means 26 and comparator means 27 are furthermore connected by control inputs via the connection 25 to the input means 9 so as to initiate special comparisons, for example with efficiency information for the same client from various lengths of time in the past, or alternatively to turn off such comparisons.

The outputs of the processing means 21 and comparator means 27 are outputs of the efficiency recording means 12, which lead to the means 14 for making the efficiency information available (see FIG. 1).

FIG. 3 illustrates schematically a procedure for the recording of individual work steps as a function of time in the course of processing of text information with a device according to FIG. 1. In this case, after a start in a block 30, an individual work step, an action, is performed in a block 31 by input into the input means 9 shown in FIG. 1. Next, in a block 32, the presence of detailed work steps is queried, and if no such detailed work steps are present (output N), a switch is made to the end of the program execution. Before branching to the end of the program execution in a block 34, however, a further check is made in a block 33 as to whether a specific lengthy duration has already been exceeded, so that no further activity is expected owing to this long duration, for example 3 min, being exceeded. If, however, the measured duration is shorter than this 3-minute maximum value, a return is made to the beginning of the procedure in the block 31.

However, if detailed work steps are present, that is to say the query result in block 32 is positive (output Y), a switch is made to a block 35, where a query is made as to whether the duration elapsed in the meantime—since performing the last detailed work step—is longer than a predetermined value (for example 10 s). If so, this last pause time is summed in a block 36 with pause times recorded earlier, after which normalization and collation for billing information, generally a conversion, takes place in a block 37, followed by display in a block 38.

If a sufficiently long pause was not found in the block 35, or following the display of the pause time in the block 38, the procedure continues to a query concerning a first specific detailed work step A1 in a block 39, and if the presence of this work step A1 is found (for example slow listening to the dictation file), summation in a block 40, conversion in a block 41, and display in a block 42 are switched to in turn, after which a return is again made to the beginning of the procedure in the block 31.

However, if this particular first work step A1 is not found in the block 39, a check is then made in a block 43 for the presence of another work step A2, and if this work step A2 is found, summation with equivalent preceding work steps in a block 44, conversion in a block 45, and display in a block 46 take place in turn. Correspondingly, the presence of other, predefined detailed work steps is queried up to a work step An in a block 47, for example deletion of symbols in the text file. Here again, summation in a block 48, conversion in a block 49, and display in a block 50 take place in turn, after which a return is made to the beginning of the procedure in the block 31.

Although the checking for the presence of the individual, predefined activities or detailed work steps A1, A2, . . . , An is illustrated in a sequential fashion in the diagram of FIG. 3, a parallel procedure for finding and measuring these individual work steps is of course also possible, as seen from the representation in FIG. 2.

It is hence possible for a wide variety of desired detailed work steps to be defined in advance with respect to their recording and then, when detected, to be measured with respect to their duration, subsequently summed and converted, before display takes place. To that end, it is frequently expedient to carry out the recognition and measurement of the work steps at the software level in order to achieve greater flexibility. This applies, in particular to the means 18, 18′, and 19 represented in FIG. 2. This makes it readily possible to individually configure the workstation 1 with respect to the efficiency recording, only minor changes to the configuration being needed even if, instead of a transcription workstation 1 as represented and described, for example, a workstation for the revision of automatically translated text were involved.

In a similar way, efficiency information can, in the described way, be determined with respect to individual detailed work steps and displayed for any other processing of information, including image processing activities, for example, without departing from the scope of the invention.

It may furthermore be mentioned that, depending on the amount or depending on the scope of the information to be processed, the system 1 for processing of information may also be formed by a network of computers which may be located inside an office or inside an office building, or decentrally distributed over various premises of a company. With such a computer network, provision may furthermore be made for the input means 19 and the screen 8 to be formed by equipment arranged remote from the network of computers, in which case the network of computers may be designed, with the assistance of the transmission/reception means 2, for communicating with the equipment and also for making a connection with input means of the equipment and with a screen of the equipment. This is advantageous in particular if the processing individual should, for example, be able to access the network of computers from his or her PC located at home, which constitutes the equipment, in order to process the information from home. With the aid of this network of computers, simultaneous processing of a plurality of text files may, for example, be made possible for a plurality of individuals, the efficiency information relating to a particular individual being accessible to the individual in question irrespective of his or her location.

1. A method of processing information which is made available in electronic form and is provided after processing in electronic form for output, wherein detailed work steps in the processing of the information are automatically recorded with respect to their time taken and efficiency information is compiled on the basis thereof and provided for output, which efficiency information indicates the efficiency of said detailed work steps.

2. A method as claimed in claim 1, wherein the efficiency information is provided for display on a screen which is used during processing of the information.

3. A method as claimed in claim 1, wherein the processing of information comprises the transcription of dictation data.

4. A method as claimed in claim 1, wherein efficiency information that indicates the efficiency of equivalent detailed work steps is automatically summed with respect to the time duration.

5. A method as claimed in claim 4, wherein the summed efficiency information is automatically expressed in terms of a specific work unit.

6. A method as claimed in claim 5, wherein the summed efficiency information is expressed in terms of a line of text in the case of processing of text information.

7. A method as claimed in claim 1, wherein, during recording of the detailed work steps as regards the time durations thereof, the time durations of pauses between the detailed work steps are also automatically recorded.

8. A method as claimed in claim 7, wherein only pauses with a time duration that is longer than a specific minimum time duration are recorded.

9. A method as claimed in claim 1, wherein the efficiency information is provided for output in the form of billing information.

10. A method as claimed in claim 4, wherein the summed efficiency information is compared with earlier, stored, summed efficiency information.

11. A system for processing information with means (6) for performing individual work steps in the processing of the information and with means (11) for making the processed information available, wherein the means (6) for performing the individual work steps are assigned further means (12) for recording the time taken by individual detailed work steps and for compiling efficiency information which indicates the efficiency of said detailed work steps, which further means (12) are connected to means (14) for making said efficiency information available for output.

12. A system as claimed in claim 11, wherein the means (11) for providing the processed information comprise display means (8), which are also connected to the means (14) for making the efficiency information available.

13. A system as claimed in claim 11, wherein the means (6) for performing individual work steps are means for processing a text file compiled automatically with the aid of speech recognition means.

14. A system as claimed in claim 11, wherein the means (12) for recording the time taken contain summation means (22) for summing the time taken to perform equivalent detailed work steps.

15. A system as claimed in claim 14, wherein the means (12) for recording the time taken contain normalization means (23) for expressing the summed efficiency information in terms of a specific work unit.

16. A system as claimed in claim 13 and claim 14, wherein the means (12) for recording the time taken contain normalization means (23) for expressing the summed efficiency information in terms of a line of text.

17. A system as claimed in claim 11, wherein the means (12) for recording the time taken are designed also to record the pause times between the detailed work steps.

18. A system as claimed in claim 17, wherein the means (12) for recording the time taken are designed to record pause times with a time duration that is longer than a specific minimum time duration.

19. A system as claimed in claim 11, wherein the means (12) for recording the time taken contain means (24) for converting the recorded time taken into billing information.

20. A system as claimed in claim 14, wherein efficiency storage means (26) are provided for storing the summed efficiency information representing the efficiency, and comparator means (27) are provided for comparing current summed efficiency information representing the efficiency with earlier, stored, summed efficiency information.
